(19) United States
(12) Patent Application Publication
(10) Pub. No.: US 2025/0341058 A1
(43) Pub. Date: Nov. 6, 2025

(54) EMBOSSED TISSUE PAPER PRODUCTS AND METHODS OF MANUFACTURING

(71) Applicant: Kimberly-Clark Worldwide, Inc., Neenah, WI (US)

(72) Inventor: Massimo Cagnone, Prato Sesia, Novara (IT)

(21) Appl. No.: 18/854,159

(22) PCT Filed: Apr. 6, 2022
(86) PCT No.: PCT/US22/23659

§ 371 Date: Oct. 4, 2024

(51) Int. Cl. D21H 27/00; A47K 10/16; B31F 1/07; D21H 27/04; D21H 27/30

(52) U.S. Cl. CPC D21H 27/002; A47K 10/16; B31F 1/07; D21H 27/04; D21H 27/30

(57) ABSTRACT

Disclosed are embossed, multi-ply tissue products, such as toilet paper or household towel, having embossing patterns with elements oriented substantially in the machine or cross-machine direction. The machine or cross-machine direction oriented elements are preferably line elements and more preferably continuous line elements. The embossing patterns are created using an embossing apparatus and process in which an embossing roll is provided with male elements having relatively shallow side wall angles, such as less than about 5 degrees and heights less than 1.00 mm. The embossing roll is paired with a mismatched counter roll to create an embossing nip therebetween.

### BACKGROUND

It is well known in the art to emboss bond multiple plies of lightweight cellulosic material to form tissue products such as bath tissues, facial tissues, paper towels, industrial wipers, foodservice wipers, napkins, medical pads, and other similar products. The embossed tissue products may comprise one, two, three or more plies. Embossing not only plies multiple webs together but may also impart the tissue product with an aesthetically pleasing pattern. Examples of apparatus and methods for embossing multi-ply paper products are disclosed, for example, in U.S. Pat. Nos. 6,733,866, 7,871,692 and 8,287,986 and U.S. Publication No. 2012/0156447.

Embossing may also be used to alter or improve certain tissue product properties such as sheet bulk and perceived softness. For example, tissue products manufactured using conventional creped wet press technology can be embossed subsequent to creping to improve bulk and perceived softness. Embossing often increases the surface area of the sheets by introducing a plurality of protuberances and thereby enhances the bulk and handfeel of the product. Examples of apparatus and methods for embossing multi-ply paper products to improve handfeel and bulk are disclosed, for example, in U.S. Publication Nos. 2005/0103456, 2018/0142422 and 2018/0135254.

Often tissue products marketed in rolls, contain a specified number of sheets per roll. Tissue embossed in conventional patterns of dot embossments, when packaged in roll form, exhibit a tendency to be non-uniform in appearance often due to compressing of the embossments as the sheet is wound onto the roll, detracting from the appearance of the rolls.

### SUMMARY

The present invention provides novel embossed tissue products and methods of manufacturing the same. In certain embodiments the invention provides embossed tissue products, produced as described herein, having novel embossing patterns, enhanced embossed pattern clarity, and improved physical properties. In particularly preferred embodiments the inventive tissue products comprise an embossing pattern having at least one element, such as a line element and more particularly a continuous line element, that is substantially oriented in either the machine or the cross-machine direction. Previously, such embossing patterns were not possible as the embossing elements needed to be skewed, typically by 10 degrees or more relative to the machine or cross-machine direction axis, to minimize vibrations during the embossing process and excessive roll wear. The inventors, however, have now discovered a new embossing process that enables the use of such patterns without excessive vibrations or roll wear.

Accordingly, in certain embodiments, the present invention provides novel embossing apparatus and processes that utilize male and female embossing elements with different geometries, commonly referred to as unmatched embossing elements. Further, the novel apparatus and process may utilize an embossing roll having male elements having relatively shallow side wall angles, such as less than about 10 degrees, more preferably less than about 5 degrees and still more preferably about 3 degrees or less. The use of male elements having shallow side wall angles not only enables the use of novel embossing patterns, but also produces a product having an embossing pattern that is visually more distant and imparts the product with improved bulk, particularly when compared to conventional embossing techniques.

Thus, in a first embodiment, the present invention provides an embossed multi-ply tissue product having a machine direction axis and a cross-machine direction axis, the product comprising: a first tissue ply having an embossing pattern disposed thereon, the embossing pattern comprising a plurality of line elements substantially oriented in the machine or the cross-machine directions; and a second tissue ply. In certain instances, the plurality of line elements have an axis of orientation that is ±5 degrees of the machine or cross-machine direction axis. In other instances, the plurality of line elements have an axis of orientation that is aligned with the machine or cross-machine direction axis.

In a second embodiment the present invention provides an apparatus for manufacturing an embossed, multi-ply tissue product, such as toilet paper or household towel, the apparatus comprising an embossing unit comprising a first heatable embossing roll, a first counter roll and a marrying roll, wherein the first heatable embossing roll and first counter roll are arranged to form a first embossing nip therebetween and the first heatable embossing roll and marrying roll are arranged to form a second nip therebetween. The first embossing roll further comprises a plurality of male embossing elements arranged to form a decorative pattern wherein at least a portion of the male embossing elements are linear elements oriented substantially in the machine direction or the cross-machine direction, the male embossing elements having a sidewall angle less than about 10 degrees, and more preferably less than about 5 degrees, and still more preferably about 3 degrees or less, such as from about 2 to about 5 degrees, and a height less than about 1.00 mm.

In certain instances, it may be preferable to provide the counter roll forming the embossing nip with female elements shaped to receive the male elements disposed on the heatable embossing roll. In a particularly preferred embodiment, the embossing nip may be configured such that there is a mismatch between the male embossing elements and the female embossing elements. Generally, a mismatch results from a difference in the sidewall angles of the male and female elements. For example, for a given pair of male and female elements the angle of the male element sidewall may be less than the angle of the female element sidewall. In those instances where the sidewall angles between the male and female elements varies, it is preferred that the sidewall angle of the male element and female element differ by at least about 3 degrees, more preferably at least about 5 degrees, such as from about 3 to about 10 degrees.

In a third embodiment the present invention provides the apparatus of the second embodiment further comprising a second heatable embossing roll and a second counter roll arranged to form a second embossing nip therebetween. The embossing unit is configured to receive the first ply with the first counter roll, to convey the first ply between the first counter roll and the first heatable embossing roll, and to further convey the first ply with the first heatable embossing roll, and wherein the embossing unit is configured to receive the second ply with the second counter roll, to convey the second ply between the second counter roll and the second heatable embossing roll, and to further convey the second ply with the second heatable embossing roll, wherein the embossing unit is configured to convey the first ply and the second ply between the first heatable embossing roll and the marrying roll.

In a fourth embodiment the present invention provides the apparatus of either the second or third embodiment wherein the embossing unit comprises an adhesive supplying unit for applying adhesive, such as lamination glue, to the first ply and/or to the second ply, the apparatus optionally being configured to supply the adhesive to at least a part of the tips of embossments formed on the first ply or the second ply, wherein the adhesive supplying unit is optionally configured to supply adhesive to the first ply while the first ply is being conveyed by the first heated embossing unit prior to the ply-bonding, and/or wherein the adhesive supplying unit is optionally configured to supply adhesive to the second ply while being conveyed by the second heated embossing unit prior to the ply-bonding.

The apparatus of any one of the foregoing embodiments may be configured and operated such that the first counter roll, the second heatable embossing roll, and the marrying roll are rotatable in a first direction and the second counter roll and the first heatable embossing roll are rotatable in another direction, opposite to the first direction.

In a fifth embodiment the present invention provides the apparatus of any one of the foregoing embodiments, wherein the first heatable embossing roll comprises a plurality of continuous linear male embossing elements substantially oriented in the machine direction or the cross-machine direction and having a height ranging from 0.20 to 1.0 mm and a sidewall angle less than about 5 degrees.

In a sixth embodiment the present invention provides the apparatus of any one of the foregoing embodiments, wherein the first heatable embossing roll comprises a plurality of discrete male embossing elements arranged to form a visually connected linear element substantially oriented in the machine direction or the cross-machine direction, the discrete male embossing elements having a height ranging from 0.20 to 1.0 mm and a sidewall angle less than about 5 degrees.

In a seventh embodiment the present invention provides the apparatus of any one of the foregoing embodiments, wherein the first heatable embossing roll comprises a plurality of male embossing elements arranged to form a linear element substantially oriented in the cross-machine direction, the male embossing elements having a height ranging from 0.20 to 1.0 mm and a sidewall angle less than about 5 degrees.

In an eighth embodiment, the present invention provides the apparatus of any one of the first through sixth embodiments further comprising a micro-embossing unit. The micro-embossing unit may comprise a micro-embossing cylinder and a counter cylinder facing the micro-embossing cylinder to form a micro-embossing nip therebetween.

In a ninth embodiment, the present invention provides the apparatus of any one of the first through seventh embodiments further comprising a wetting station for wetting the first and/or second plies prior to being embossed. Preferably the wetting station comprises one or more wetting units configured to wet the first and the second plies. The wetting station may comprise a nozzle system for spraying a liquid onto the ply or may comprise a dosing roller system.

In a particularly preferred embodiment, the apparatus comprises a micro-embossing unit and a wetting unit where the wetting unit is configured to wet the outer surface of the first and second plies which is brought into contact with the micro-embossing cylinder in a micro-embossing nip. The micro-embossing unit may further comprise a heating means configured to dry the wet tissue ply.

Although in certain preferred embodiments the apparatus comprises a wetting station and micro-embossing unit, either, or both may be deactivated such that the tissue plies are not micro-embossed or wetted prior to embossing.

In a tenth embodiment the present invention provides a method of manufacturing a multi-ply embossed tissue product, such as toilet paper or household towel, comprising the steps of conveying, a first tissue ply and a second tissue ply, the plies each having a basis weight ranging from about 14 to about 30 grams per square meter (gsm), receiving the first tissue ply in a first embossing nip formed between a first counter roll and a first heatable embossing roll heated to a temperature ranging from about 90 to 180° C., wherein the first heatable embossing roll comprises a plurality of male elements arranged to form a linear, substantially machine direction or the cross-machine direction oriented element, each of the plurality of male elements having a height ranging from 0.20 to 1.0 mm and a sidewall angle less than about 5 degrees, and ply-bonding the first embossed tissue ply and the second tissue ply between the first heatable embossing roll and a marrying roll.

In an eleventh embodiment the present invention provides a method of manufacturing a multi-ply, embossed, tissue product comprising the steps of: providing an embossing unit comprising a first heatable embossing roll, a first counter roll and a marrying roll, wherein the first heatable embossing roll and first counter roll are arranged to form a first embossing nip therebetween and the first heatable embossing roll and marrying roll are arranged to form a second nip therebetween, the first embossing roll further comprises a plurality of male embossing elements arranged to form a first embossing pattern wherein at least a portion of the male embossing elements are linear elements oriented substantially in the machine direction or the cross-machine direction and have a sidewall angle from about 2 to about 5 degrees and a height less than about 1.00 mm; conveying a first tissue ply into the first embossing nip to emboss the first tissue ply with the first embossing pattern; conveying the first tissue ply into the second nip; conveying a second tissue ply into the second nip; and joining the first and second tissue plies together in the second nip to form a multi-ply tissue product, wherein the first embossing pattern disposed on the first ply comprises a plurality of line elements substantially oriented in the machine or the cross-machine direction.

### DESCRIPTION OF THE DRAWINGS

FIG. 1 is a plane view of an embossing pattern useful in preparing embossed tissue products of the present invention;

FIG. 2 is a top plane view of an embossed tissue product according to one embodiment of the present invention;

FIG. 3 is a perspective view of an embossed tissue product according to one embodiment of the present invention;

FIG. 4 is a perspective view of an embossed tissue product according to another embodiment of the present invention;

FIG. 5 is a perspective view of an embossed tissue product according to yet another embodiment of the present invention;

FIG. 6 is a perspective view of an embossed tissue product according to still another embodiment of the present invention;

FIG. 7 is a schematic illustration of an embossing apparatus and process for manufacturing an embossed tissue product of the present invention; and

FIG. 8 is a detailed cross-sectional view of an embossing nip useful in manufacturing an embossed tissue product of the present invention.

### DEFINITIONS

As used herein the term “machine direction” or “MD” generally refers to the direction in which a tissue web or product is produced. The term “cross-machine direction” or “CD” refers to the direction perpendicular to the machine direction.

As used herein the term “basesheet” refers to a tissue web formed by any one of the papermaking processes described herein that has not been subjected to further processing, such as embossing, calendering, treatment with a binder or softening composition, perforating, plying, folding, or rolling into individual rolled products.

As used herein the term “tissue product” refers to products made from basesheets and includes, bath tissues, facial tissues, paper towels, industrial wipers, foodservice wipers, napkins, medical pads, and other similar products.

As used herein the term “ply” refers to a discrete tissue web used to form a tissue product. Individual plies may be arranged in juxtaposition to each other. In a preferred embodiment, tissue products prepared according to the present invention comprise two or more plies arranged in facing relation to one another.

As used herein, the term “layer” refers to a plurality of strata of fibers, chemical treatments, or the like, within a ply. A “layered tissue web” generally refers to a tissue web formed from two or more layers of aqueous papermaking furnish. In certain instances, the aqueous papermaking furnish forming two or more of the layers comprises different fiber types.

As used herein the term “basis weight” generally refers to the conditioned weight per unit area of a tissue and is generally expressed as grams per square meter (gsm). While the basis weights of tissue products prepared according to the present invention may vary, in certain embodiments the products have a total basis weight of about 30 gsm or greater, such as about 34 gsm or greater, such as about 36 gsm or greater, such as from about 30 to about 65 gsm, such as from about 32 to about 60 gsm, such as from about 38 to about 48 gsm.

As used herein, the term “caliper” refers to the thickness of a tissue product, web, sheet, or ply, typically having units of microns (μm).

As used herein, the term “sheet bulk” refers to the quotient of the caliper (μm) divided by the basis weight (gsm) and having units of cubic centimeters per gram (cc/g). Tissue products prepared according to the present invention may, in certain embodiments, have a sheet bulk of about 6.0 cc/g or greater, such as about 8.0 cc/g or greater, such as about 10.0 cc/g or greater, such as from about 6.0 to about 14.0 cc/g.

As used herein, the term “geometric mean tensile” (GMT) refers to the square root of the product of the machine direction tensile strength and the cross-machine direction tensile strength of the web. The GMT of tissue products prepared according to the present invention may vary, however, in certain instances the GMT may be about 800 g/3″ or greater, such as about 900 g/3″ or greater, such as about 1,000 g/3″ or greater, such as from about 800 to about 1,700 g/3″.

As used herein “substantially oriented” when used in reference to an embossed element, a motif or a pattern generally means that the difference in the axis of orientation between the element, motif or pattern and the MD or CD axis is less than 5 degrees, such as less than about 4 degrees, such as less than about 3 degrees, such as about 2 degrees or less, such as from about 0 to about 5 degrees. In certain instances, the element, motif, or pattern may have a principle axis that is substantially aligned with the MD or CD axis.

As used herein the term “line element” refers to an element in the shape of a line, which may be continuous, discrete, interrupted, or a partial line with respect to a tissue product on which it is present. The line element may be of any suitable shape such as straight, curled, curvilinear, and mixtures thereof. In one example, the line element may comprise a plurality of discrete elements, such as dots, dashes, or broken lines for example, that are disposed relative to one another to form an element in the shape of a line having a substantially connected visual appearance.

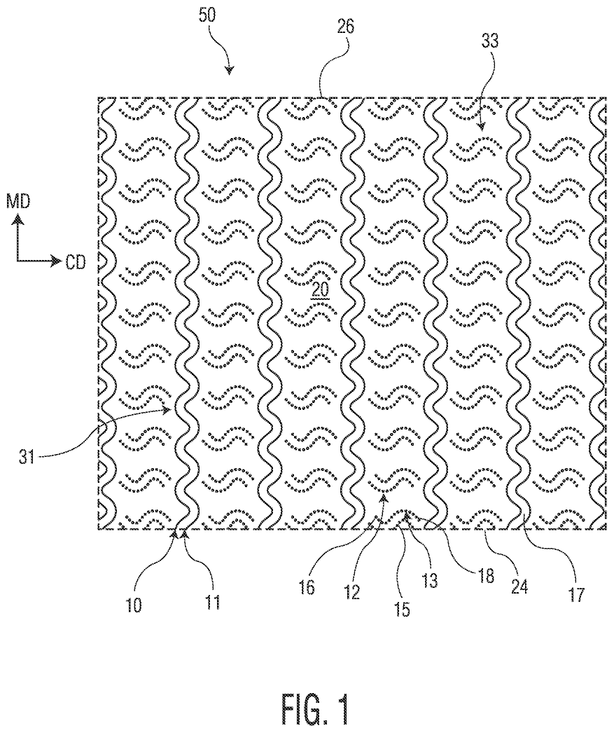

As used herein the term “continuous,” when referring to an element disposed on the surface of a tissue product, such as a design element, a motif, or a pattern, means that the element extends throughout one dimension of the tissue product surface. Non-limiting examples of continuous line elements 10, 11 are illustrated in FIG. 1 where first and second line elements 10, 11 having a wave-like shape that extend from a first edge 24 to a second edge 26 of the embossing pattern 50.

As used herein the term “discrete,” when referring to an element disposed on the surface of a tissue product, such as a design element, a motif, or a pattern, means that the element is visually unconnected from other elements and does not extend continuously in any dimension of the tissue product surface. Generally, a discrete element will have a beginning and an end, although both may not be visible within a given surface, such as the surface of embossing roll or the surface of a tissue product. Non-limiting example of discrete line elements 12 and 13 are illustrated in FIG. 1 where dot emboss elements 15 are arranged to form curvilinear line elements 12 and 13 having first and second ends 16, 18. The line elements 12 and 13 do not extend continuously in any dimension of the surface 20 and are visually unconnected from the continuous line elements 10, 11 forming a first motif 31.

As used herein the terms “element” and “design element” generally refer to a shape or combination of shapes that visually create a distinct component of a pattern. A design element is a curvilinear design element where it is at least partially formed by a curvilinear line element. A design element may be continuous or discrete. It is not necessary that a design element form a recognizable shape. The design element may be textured having a z-directional elevation relative to the plane of the tissue product, such as protrusions or depressions formed either by wet molding or embossing the tissue product. In other embodiments the design element may not be textured and be formed by printing on the tissue product surface.

As used herein the term “closed,” when referring to a design element, generally means that the design element has no beginning or end. In certain instances, an element may be closed despite having breaks or gaps provided that the overall visual appearance is that the element has no beginning and no end.

As used herein the term “open,” when referring to a design element, generally means that design element has a beginning and/or an end. A design element may be open even though it begins or ends at the edge of a given sheet. In certain instances, a design may be open even though it begins at one edge of a sheet and continues across the sheet to another edge.

As used herein the term “pattern” generally refers to the arrangement of one or more design elements in a regular repeating fashion. Within a given pattern the design elements may be the same or may be different, further the design elements may be the same relative size or may be different sizes. For example, with reference to FIG. 1, an embossing pattern 50 may comprise a first motif 31 formed from a pair of spaced apart, substantially machine direction oriented continuous line elements 10, 11. The second motif 33 is formed from a pair of spaced apart, substantially cross machine-direction oriented discrete line elements 12, 13. Together the first and second motifs 31, 33 are arranged in a repeating fashion to form the pattern 50.

As used herein the term “motif” generally refers to the recurrence of one or more design elements within a pattern. The recurrence of the design element may not necessarily occur within a given sheet, for example, in certain embodiments the design element may be a continuous design element extending across two adjacent sheets separated from one another by a line of perforations. Motifs are generally non-random repeating units that form a pattern. Two non-limiting examples of motifs 31 and 33 are shown in FIG. 1.

As used herein the term “micro-embossments” generally refers to a plurality of discrete embossments disposed on a tissue ply where the number of embossments per square centimeter of tissue surface area (embossment density) is at least 25 embossments/cm², such as at least about 30 embossments/cm², such as at least about 40 embossments/cm², such as from 25 to about 80 embossments/cm². In certain embodiments the micro-embossments may consist of small protuberances on a given tissue ply and be formed by small protrusions on an embossing roll which press against and into the tissue ply to be embossed. The micro-embossments may be arranged in a pattern and may cover at least about 6 percent of the ply surface area, such as from about 6 to about 15 percent of the ply surface area.

As used herein the term “dot embossment” or “dot emboss element” means an embossment or an embossing element that exhibits an aspect ratio of about 1:1.25 or less, such as an aspect ratio from about 1.0 to about 1.25. Non-limiting examples of dot embossments are embossments having a circular, oval, square, or triangular cross-sectional shape. One non-limiting example of a dot emboss element 15 is shown in FIG. 1.

As used herein the term “linear embossment” or “linear embossment element” means an embossment having a length dimension that is greater than its width dimension such that the embossment exhibits an aspect ratio of greater than about 1:1.25. One non-limiting example of a linear emboss element 14 is shown in FIG. 1.

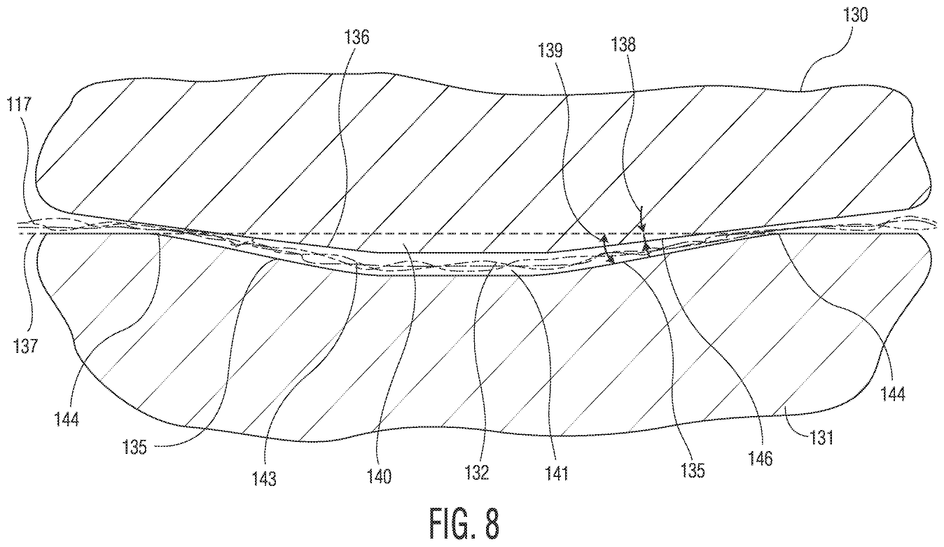

As used herein the term “mismatch” means that the sidewall angle of a male element disposed on the embossing roll is different than the sidewall angle of a corresponding female element disposed on the counter roll. Preferably the difference in sidewall angle between corresponding male and female elements is at least about 3 degrees, more preferably at least about 5 degrees, such as from about 3 to about 10 degrees. For purposes herein, the sidewall angle is measured relative to the plane of the undeflected web during embossing, with the maximum angle being perpendicular to the undeflected web. Measurement of sidewall angle is further illustrated in FIG. 8.

### Description

It has now been discovered that embossed tissue products having improved physical properties and embossed pattern clarity may be produced using an embossing apparatus having male and female embossing elements with relatively shallow and different geometries. Preferably, the male elements have a side wall angle less than about less than about 10 degrees, more preferably less than 5 degrees, still more preferably about 3 degrees or less, such as about 2 degrees, such as about 2.5 degrees, such as about 3 degrees, such as about 3.5 degrees, such as about 4 degrees, such as from about 2 to about 5 degrees. The use of male elements having the foregoing sidewall angles produces embossed tissue products having more visually distinct embossing patterns and enables the use of patterns having elements substantially oriented in the machine or cross-machine direction. Further, the apparatus may be used to produce products having improved bulk, particularly when compared to conventional embossing techniques.

In addition to mismatched male and female embossing elements having shallow wall angles, the apparatus of the present invention may utilize a heated embossing roll and a means of wetting the tissue ply prior to embossing. Accordingly, in one particularly preferred embodiment, embossed tissue products of the present invention are embossed by an embossing apparatus comprising a means for wetting the tissue web prior to the web entering the embossing nip and an embossing nip comprising a heated steel male embossing roll and a deformable female embossing roll, where the embossing male and female embossing elements are unmatched. Embossing the tissue product in this manner may not only improve embossing pattern clarity and the facilitate the use of novel embossing patterns, but it may also lower embossing nip loads, which preserves the integrity of the tissue web and reduces tensile degradation.

The foregoing embossing/counter roll combination permits the use of novel embossing patterns, particularly patterns having elements oriented substantially along the machine or cross-machine direction axis. For example, the present invention enables the use of embossing patterns having elements, particularly line elements and more particularly continuous line elements having an axis of orientation that is less than 10 degrees of the MD or CD axis. In a particularly preferred embodiment the embossing pattern, motif or element has an axis of orientation that is less than about 5 degrees, such as less than about 4 degrees, such as about 3 degrees or less, such as from about 0 to about 5 degrees of the MD or the CD axis. Use of such patterns had not been previously possible because of the difficulty in matching the male and female elements which caused excessive roll vibration and wear.

One embodiment of an embossing pattern 50 useful in the present invention is shown in FIG. 1. The embossing pattern 50 may comprise a plurality of male elements, which may be in the form of either dot elements 15 or linear elements 17. In the illustrated embodiment the dot elements 15 are oriented substantially in the cross-machine direction (CD) and the linear elements 17 are oriented substantially in the machine direction (MD). Further, the MD oriented linear male elements 17 consist of a pair of parallel line elements 10, 11.

With continued reference to FIG. 1, the pattern 50 comprises male elements that are not arranged to form substantially MD oriented elements, such as the dot emboss elements 15, which are arranged to form cross-machine direction oriented discrete line elements 12, 13. While the inclusion of CD oriented elements in the pattern is possible, it is generally preferred, that the predominate element in the pattern, as measured by the projected surface area of the male elements, are substantially MD oriented male elements.

Regardless of whether the line elements are oriented in the MD or CD, or whether they are continuous or discrete, the line elements may be formed from a plurality of discrete dot elements that are arranged to give the appearance of a visually connected line element or they may be linear elements. In certain embodiments, it may be preferable that the pattern comprise both discrete dot elements and linear elements.

A wide breadth of design elements may be selected from when developing patterns useful in the present invention. Particularly preferred design elements are those having a curvilinear shape and more particularly curvilinear line elements, such as line elements having a wave-like shape, such as a sinusoidal wave. Although patterns useful in the present invention are preferably formed from curvilinear design elements, one skilled in the art will appreciate that a pattern may include shapes that are not curvilinear.

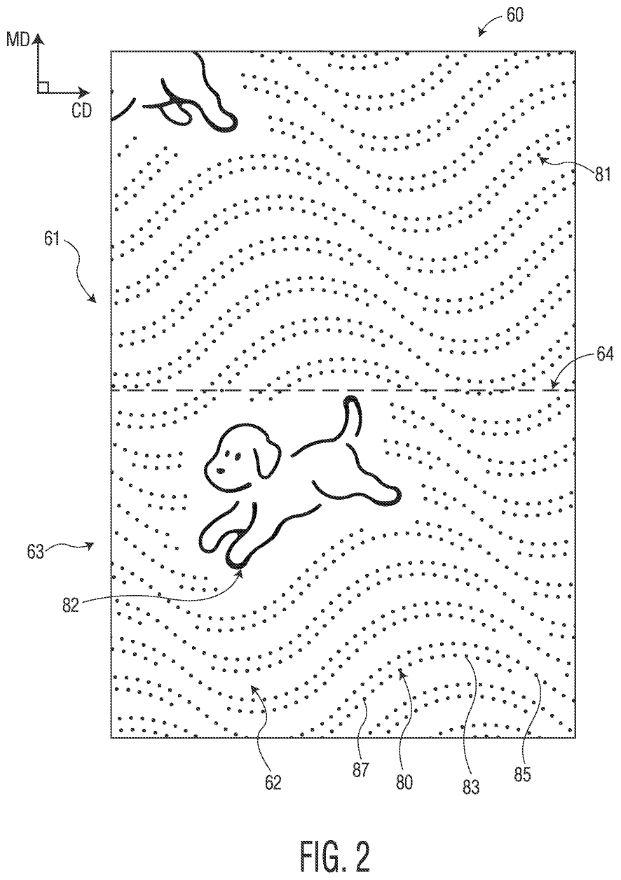

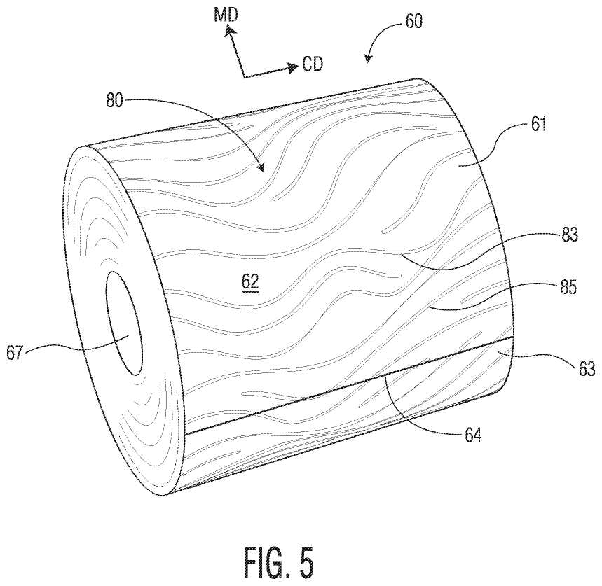

Several examples of patterns useful in present invention are illustrated in FIGS. 2-6. For example, FIG. 2 illustrates a tissue product 60 comprising first and second sheets 61, 63 separated from one another by a line of perforations 64. Each sheet 61, 63 has an embossing pattern 80 disposed on its surface 62. The pattern 80 comprises a first motif 81 and a second motif 82. The first motif 81 comprises a first curvilinear line element 83 and a second curvilinear line element 85, each formed from dot embossments 87 arranged to provide the appearance of a visually connected line. The first and second line elements 83, 85 are continuous and substantially oriented in the cross machine direction.

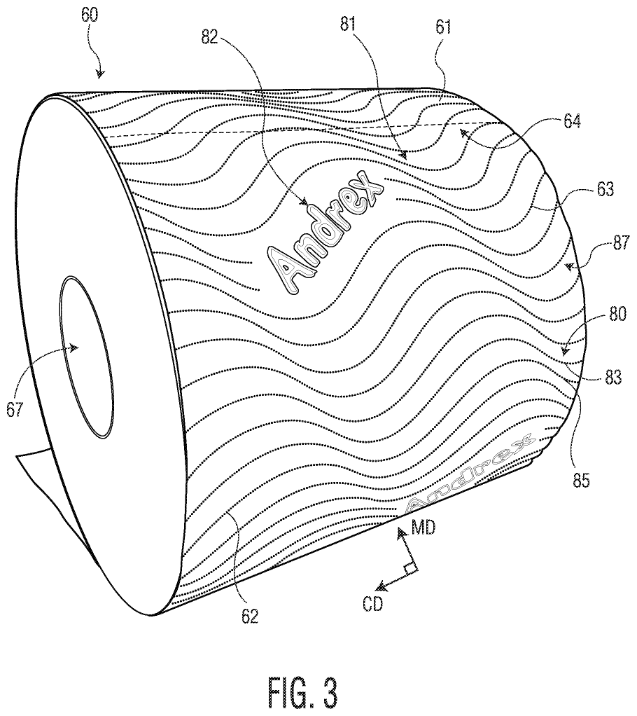

FIG. 3 illustrates another tissue product 60 having embossing pattern 80 disposed on its surface 62. The rolled tissue product 60 comprises tissue sheets 61, 63 spirally wound around a core 67. The embossing pattern 80 comprises a first motif 81 and a second motif 82. The first motif 81 consists of open, continuous, of wave-like line elements 83, 85. The line elements 83, 85 are substantially oriented in the cross-machine direction and spaced apart from one another in the machine direction. The MD spacing between line elements 83, 85 varies so as to create a three-dimensional effect.

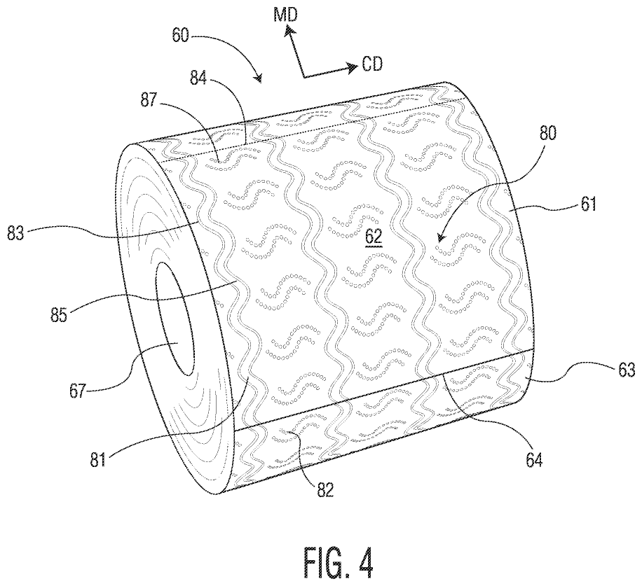

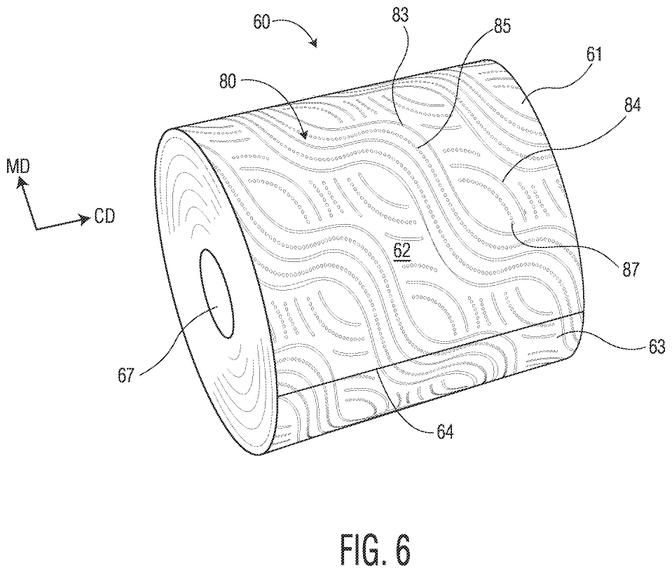

Still other embossed tissue products 60 within the scope of the present invention are illustrated in FIGS. 4-6. Generally, the embossing pattern 80 may comprise a plurality of linear elements 83, 85, which are preferably continuous in at least one dimension of the product and oriented substantially in the machine direction or cross-machine direction. In certain embodiments, in addition to continuous line elements, the pattern 80 may comprise discrete line elements 84, which in certain instances, such as illustrated in FIGS. 4 and 6, may be formed by dot embossments 87. The discrete elements may be substantially aligned with the continuous line elements or may be arranged in a different orientation. In certain embodiments it may be preferable that the predominate embossed elements in the pattern, as measured by the surface area of the embossments relative to the total sheet area, are substantially MD oriented.

Tissue basesheets embossed in accordance with this invention can be any web suitable tissue webs, which for purposes herein means webs intended for use as facial tissue, bath tissue, table napkins and paper towels, the web can be layered or nonlayered, creped or uncreped, wet pressed or throughdried, single-ply or two-ply or multi-ply, and can comprise natural and/or synthetic fibers.

Tissue basesheets useful in the present invention may be made by any well-known wet-laid papermaking processes such as, for example, creped wet pressed, modified wet pressed, creped through-air dried (CTAD) or uncreped through-air dried (UCTAD). For example, creped tissue webs may be formed using either a wet pressed or a modified wet pressed process such as those disclosed in U.S. Pat. Nos. 3,953,638, 5,324,575 and 6,080,279, the disclosures of which are incorporated herein in a manner consistent with the instant application. In these processes the embryonic tissue web is transferred to a Yankee dryer, which completes the drying process, and then creped from the Yankee surface using a doctor blade or other suitable device.

In other instances, the tissue basesheet may be manufactured by a through-air dried process known in the art. In such processes the embryonic web is noncompressively dried. For example, textured tissue plies may be formed by either creped or uncreped through-air dried processes. Particularly preferred are uncreped through-air dried webs, such as those described in U.S. Pat. No. 5,779,860, the contents of which are incorporated herein in a manner consistent with the present disclosure.

In still other instances the tissue basesheet may be manufactured by a process including the step of using pressure, vacuum, or air flow through the wet web (or a combination of these) to conform the wet web into a shaped fabric and subsequently drying the shaped sheet using a Yankee dryer, or series of steam heated dryers, or some other means, including but not limited to tissue made using the ATMOS process developed by Voith or the NTT process developed by Metso; or fabric creped tissue, made using a process including the step of transferring the wet web from a carrying surface (belt, fabric, felt, or roll) moving at one speed to a fabric moving at a slower speed (at least 5 percent slower) and subsequently drying the sheet. Those skilled in the art will recognize that these processes are not mutually exclusive, e.g., an uncreped TAD process may include a fabric crepe step in the process.

Multi-ply tissue products may be constructed from two or more plies that are manufactured using the same or different tissue making techniques. In a particularly preferred embodiment, the multi-ply tissue product comprises two or three plies wherein at least one of the plies is a through-air dried ply.

The multi-ply embossed tissue products of the present invention generally have a total product basis weight of at least about 20 gsm, such as at least about 30 gsm, such as at least about 40 gsm, such as from about 20 to about 70 gsm, such as from about 30 to about 65 gsm, such as about 40 to about 60 gsm. In certain instances, the multi-ply embossed tissue products may comprise two, three or four tissue plies where the basis weight of each individual tissue ply is less than about 25 gsm, such as from about 10 to about 20 gsm, such as from about 10 to about 15 gsm.

The multi-ply embossed tissue products of the present invention generally have a geometric mean tensile (GMT) of about 800 g/3″ or greater, such as about 900 g/3″ or greater, such as about 1,000 g/3″ or greater, such as from about 800 to about 1,700 g/3″, such as from about 1,000 to about 1,500 g/3″. In certain instances, the multi-ply embossed tissue products may comprise two, three, or four tissue plies where the GMT of each individual tissue plie is less than about 600 g/3″, such as from about 200 to about 425 g/3″, such as from about 350 to about 550 g/3″.

In other instances, the multi-ply embossed tissue products of the present invention may have a sheet bulk greater than about 6.0 cc/g, such as from about 6.0 to about 14.0 cc/g. In certain instances, at the foregoing sheet bulks, the tissue products may have a sheet caliper greater than about 300 μm, such as greater than about 400 μm, such as greater than about 500 μm, such as greater than about 600 μm, such as from about 300 to about 1,000 μm.

The foregoing multi-ply tissue products may be converted into rolled tissue products, such as rolled bath tissue products, comprising a multi-ply embossed tissue web spirally wound about a core. Such rolled tissue products may comprise a plurality of connected, but perforated, multi-ply tissue sheets that may be separated from adjacent sheets.

Regardless of the tissue making process used to produce the individual plies, the resulting multi-ply tissue product has an uppermost ply having a plurality of first embossments disposed in a pattern. The pattern preferably comprises a plurality of elements, particularly line elements, substantially oriented in the machine or the cross-machine directions. For example, with reference to FIG. 4, the tissue product 60 comprises an embossing pattern 80 having both substantially MD and CD oriented line elements 83, 85. In the illustrated embodiment both the MD and CD oriented line elements 83, 85 are curvilinear. The MD oriented elements 83 are generally oriented substantially along the MD axis and are continuous in the MD. The CD oriented elements 85 are generally oriented substantially along the CD axis and are discrete.

To produce multi-ply tissue products, multiple basesheets are prepared and then combined using an embossing and lamination process. Typically, embossing is carried out in the nip between an embossing roll, and an anvil roll, also referred to herein as a counter roll. The embossing roll generally has a plurality of protrusions on its circumferential surface leading to embossments in the tissue ply.

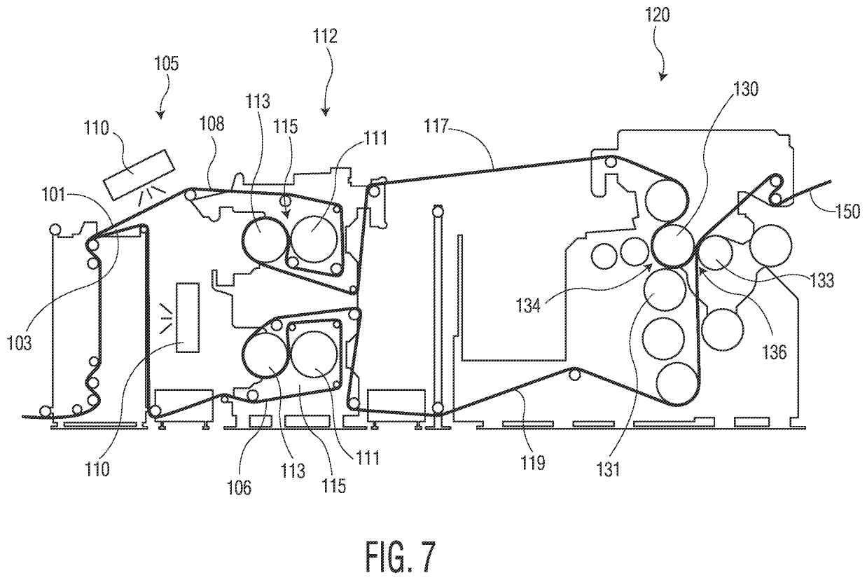

One particularly preferred embossing apparatus for embossing a tissue ply according to the present invention is illustrated in FIG. 7. In the illustrated embodiment the embossing apparatus comprises an unwinding station (not illustrated) for unwinding a first and a second tissue ply 101, 103 and a wetting station 105 for wetting the first and second tissue plies 101, 103. The wetting station 105 may include first and second liquid applicators 110 configured to apply a liquid to at least one surface of the first and second tissue plies 101, 103 and to yield first and second wetted tissue plies 106, 108. For example, the liquid applicators may comprise a nozzle system or a dosing roller configured to apply water to at least the outer surface of the web as it is conveyed past the applicator. In certain embodiments, it may be preferable to configure the liquid applicators such that they wet the surface of the tissue ply that will be brought into contact with an embossing cylinder later in the embossing process.

The one or more wetting units may be configured to wet at least one tissue ply before the ply is conveyed through an embossing nip. The at least one ply may be the first or second tissue ply, or in some instances may be both the first and the second tissue ply. The same wetting unit may be configured to wet both the first and the second tissue plies or the separate wetting units may be used to wet the first and the second tissue plies. Further, the wetting units may be configured such that one or more plies are wetted prior to micro-embossing, or in those instances where the plies are not micro-embossed, may be configured to apply a liquid prior to embossing.

The wetting unit may be configured to provide a controlled amount of liquid, such as water, to the tissue ply to be wetted based upon the basis weight of the tissue ply. For example, the unit may be configured to add a liquid in the range from about 1 to about 15 percent of the basis weight of the tissue ply, such as from about 2 to about 10 percent and more preferably from about 4 to about 8 percent to the at least one ply with an amount of liquid in the range of 2 to 12 percent of the basis weight of the ply, or optionally 4 to 10 percent of the basis weight of the ply. In a particularly preferred embodiment, a first and second web are wetted by the application of 4 to 8 weight percent water immediately prior to being embossed by passing the wetted web through an embossing nip formed by a heatable steel embossing roll having the novel embossing pattern described herein and an opposed, unmatched resilient countertroll.

With continued reference to FIG. 7, first and second wetted tissue plies 106, 108 may be micro-embossed by passing the plies through a micro-embossing station 112, which may comprise a micro-embossing cylinder 111 and a counter cylinder 113 facing the micro-embossing cylinder 111 and forming micro-embossing nip 115 therebetween and through which a wetted tissue ply is conveyed and micro-embossed. While the apparatus and process of FIG. 7 includes a micro-embossing apparatus and step, micro-embossing is not necessary and in certain embodiments the inventive products may be produced without micro-embossing.

In those instances where one or more plies are micro-embossed, one or more micro-embossing units may be provided with a heating means for heating the wetted tissue ply prior to, or during, the micro-embossing process. For example, the heating means may be configured to heat at least a portion of the micro-embossing cylinder surface such that the wetted web is heated as it is conveyed over the cylinder's surface and through the micro-embossing nip. In such embodiments the extent to which the wetted tissue ply wraps the micro-embossing cylinder may be varied so as to achieve the desired degree of heating. In certain instances, the wrapping angle of the wetted tissue play may range from about 120 to about 300 degrees.

Alternatively, the heating means may be disposed outside of the micro-embossing cylinder and configured to heat at least one surface of the wetted tissue ply. In other instances, more than one heating means may be provided, such as both outside and within the micro-embossing cylinder. The heating means may comprise an electrical resistor, which may be embedded in the micro-embossing cylinder, or an oil, water or steam heating system that may be at least partially embedded in the micro-embossing cylinder.

The micro-embossed plies may then be conveyed to a rewinding station or a joining station. In the illustrated embodiment of FIG. 7, the micro-embossed plies 117, 119 are conveyed to an embossing and laminating unit 120 adapted to further emboss and join the micro-embossed plies 117, 119. Lamination of the plies may be carried out with or without the addition of an adhesive. In some embodiments the plies may be joined solely by a mechanical system, such as a ply-bonding system. In other embodiments the plies may be joined by the addition of a liquid, such as water, immediately prior to embossing the ply using a heatable embossing roll, followed by ply attachment.

The embossing and laminating unit 120 preferably comprises a heating means for heating the surface of the upper patterned roll 130, also referred to as an embossing roll, and/or the surface of the lower counter roll 131, also referred to as the embossing counter roll. The heating means preferably heats the surfaces of one or more rolls such that the temperature of the micro-embossed ply is heated to a temperature greater than about 80° C., more preferably about 90° C. or more, still more preferably about 100° C. or more, such as from about 80 to about 200° C., such as from about 100° C. to about 180° C. The heating means may be selected from ones known in the art, such as those described above, and may be either housed within the roll for heating by conduction or housed outside the roll and facing the surface of the roll for heating by radiation and/or convection.

Preferably, as shown in FIG. 7, the embossing and laminating unit 120 comprises two pairs of opposed rolls 130, 131 for embossing and laminating the first and second micro-embossed plies 117, 119 to form a multi-ply embossed tissue product 150. Generally, the first ply 117 may be embossed by conveying the ply through a first embossing nip 134 formed between the first pair of opposed rolls 130, 131. After the first ply 117 has been embossed it is conveyed to a second nip 136 formed between the upper patterned roll 130 and a marrying roll 133. The second ply 119 is also conveyed to the second nip 136 where it is joined in facing relationship with the first ply 117 as it is passed through the second nip 136. Joining of the first and second plies 117, 119 may be carried out with or without the use of an adhesive.

In certain instances, the first pair of opposed rolls 130, 131 consist of an upper steel embossing roll 130 and a lower rubber embossing counter roll 131. As noted previously, it is generally preferred that the steel embossing roll 130 comprise a plurality of male embossing elements that extend from the surface of the embossing roll surface and have a sidewall angle less than about 10 degrees, more preferably less than 5 degrees, still more preferably about 3 degrees. The male elements may have a height, generally measured from a plane normal to the surface of the embossing roll of less than about 1.00 mm and more preferably less than about 0.80 mm, such as from about 0.50 to about 1.00 mm.

Further, it is generally preferred that the male elements disposed on the embossing roll and the female elements disposed on the corresponding rubber embossing counter roll are unmatched. In this manner the sidewall angles of the male and female embossing elements differ sufficiently to provide differential compression and/or shear on certain portions of the web when the embossing elements are engaged, meaning that all portions of the web which form an embossment sidewall are not compressed and/or-sheared the same. One non-limiting example of an unmatched male and female embossing elements 140, 141 and the tissue ply 117 disposed therebetween is shown in FIG. 8.

The method may comprise the step of applying an adhesive, such as lamination glue, to the first ply and/or to the second ply, prior to the step of laminating the first and second plies to form a multi-ply tissue product. The use of an adhesive may further ensure the plies are properly and securely laminated. In particular, the adhesive may be applied shortly prior to the lamination step such that the adhesive does not prematurely dry, and that lamination is timely performed after application of the adhesive. In a particularly preferred embodiment, an adhesive is applied to the first ply while the first ply is being conveyed by a heated embossing roll followed by lamination in a second nip formed between the heated embossing roll and a marrying roll. Preferably the embossing roll is heated to at least about 80° C., more preferably at least about 90° C. or more, and still more preferably at least about 100° C., such as from about 80 to about 200° C., such as from about 100 to about 180° C.

Accordingly, in certain embodiments the joining station may be configured such that the upper steel embossing roll abuts a glue delivery assembly and a marrying roll to further laminate and adhesively join the first embossed ply to the second ply to form a multi-ply embossed tissue product according to the present invention. In particular, the upper steel embossing roll may abut an adhesive delivery applicator which distributes adhesive onto the embossed ply, particularly the protruding embossments of the embossed ply. After application of the adhesive the embossed and adhesively treated ply may be joined to the second ply by a marrying roll, which may be arranged such that it abuts the upper steel embossing roll. In this manner, the upper steel embossing roll and marrying roll may form a nip therebetween through which the plies pass and are joined together to form a multi-ply tissue product.

In other instances, the ply attachment may be carried out without the use of an adhesive by wetting one or more plies immediately prior to embossing the wetted plies using a heatable embossing roll as described herein. Surprisingly, the combination of ply wetting and heated embossing yield a multi-ply embossed tissue product having ply attachment strength that is comparable or better than products prepared using an adhesive.

In other embodiments the inventive tissue products may be manufactured using an embossing process by conveying a first micro-embossed ply through an embossing nip formed between a heated steel embossing roll and a rubber counter roll where the steel embossing roll comprises male embossing elements having a relatively shallow element angle, such as less than about 5 degrees and a height less than about 1.0 mm. Preferably the steel embossing roll and the rubber counter roll are mismatched. The second micro-embossed ply may be embossed in a similar manner by conveying the second ply through a second embossing nip formed between a second heated steel embossing roll and a second rubber counter roll. The two embossed plies may then be laminated together by passing them between the first heatable embossing roll and a marrying roll. When forming the embossed tissue product in this manner it is generally preferred that the first counter roll, the second heatable embossing roll, and the marrying roll are rotated in a first direction, and the second counter roll and the first heatable embossing roll are rotated in another direction, opposite to the first direction.

In a particularly preferred embodiment, the embossing apparatus of the present invention comprises a heatable embossing roll comprising a plurality of male elements and an opposed counter roll comprising a plurality of female embossing elements. Preferably the male and female embossing elements are “unmatched”. As used herein, this term is intended to mean that the male and female embossing elements are not identical in shape, but still are positioned relative to each other in registry such that they engage one another to impart an embossment to a tissue ply disposed therebetween. This is meant to distinguish from conventional “matched” steel embossing elements in which the male elements are engraved first, and the female elements are subsequently made from the male elements, or vice versa, so that both elements are virtually inverse or reciprocal images of each other within the practicalities of manufacturing tolerances. This is not the case with the embossing elements of the present embodiment where the angle of the male and female element sidewalls differ so as to provide differential compression on certain portions of the tissue ply when it is engaged between the elements. In this manner, as the tissue ply is conveyed through the embossing nip and engaged by the male and female elements the ply is subjected to differing degrees of compression, particularly along the leading and trailing edges of the ply within the nip.

In addition to the male and female emboss elements being unmatched, it is generally preferable that the male elements have sidewall angles that are relatively shallow, such as less than 5 degrees, still more preferably about 3 degrees or less, such as about 2 degrees, such as about 2.5 degrees, such as about 3 degrees, such as about 3.5 degrees, such as about 4 degrees, such as from about 2 to about 5 degrees. Without being bound by any particular theory, it is believed that shallow sidewall angles, particularly when in an unmatched configuration, enable the use of substantially machine or cross-machine direction oriented emboss elements, improve the clarity of the resulting emboss pattern and improves sheet bulk.

Generally, it is preferred that the male elements be formed from a non-deformable material, such a steel, and that female elements be formed from a deformable material. For example, the male elements can be steel, and the female elements can be a deformable material, such as rubber. Generally deformable materials, such as rubber, are not only more forgiving with respect to degrading the strength of the web during embossing, but they also are suitable for laser engraving. As used herein, “rubber” is meant to include any relatively deformable material having a Shore A hardness of about 100 or less and preferably about 90 or less. Other suitable deformable materials include nylon, polyesters, polyurethane, polytetrafluoroethylene (Teflon), poly(vinylidene fluoride co hexafluoropropylene) (Viton), and the like.

With reference now to FIG. 8, a preferred embossing nip formed between a first embossing roll 130 and a counter roll 131 is illustrated. In the illustrated embodiment the tissue ply 117, which may have been micro-embossed prior to being conveyed into the embossing nip, is deflected between a male embossing element 136 and an unmatched female embossing element 141 to from an embossment 143. Because the male 136 and female 141 elements are unmatched the ply 117 is compressed to a greater extent at the leading and trailing edges 144. Generally, the mismatch between the embossing elements 136, 141 is achieved by providing the female elements 141 in the counter roll with sidewalls 135 having an angle 139 (measured relative to a line 137 drawn tangential to the counter roll 131 surface) that is greater than the sidewall angle 138 of the male element 136. As previously described, the sidewall angles 136, 138 are measured relative measured relative to a line 137 drawn tangential to the counter roll 131 surface. The sidewall angle of the male embossing element 136 as shown in FIG. 8 is indicated by the angle represented by the double arrow 138. The sidewall angle of the female embossing element 141 is the angle represented by the double arrow 139. It is preferred that the male 136 element be formed from steel and the female embossing element 141 be made of rubber to facilitate deformation of the ply and avoid tearing.

We claim:

1. An embossed multi-ply tissue product having a machine direction axis and a cross-machine direction axis, the product comprising:
a. a first tissue ply having an embossing pattern disposed thereon, the embossing pattern comprising a plurality of line elements substantially oriented in the machine or the cross-machine directions; and
b. a second tissue ply.

2. The embossed multi-ply tissue product of claim 1 wherein the plurality of line elements have an axis of orientation that is ±5 degrees of the machine or cross-machine direction axis.

3. The embossed multi-ply tissue product of claim 1 wherein the plurality of line elements have an axis of orientation that is aligned with the machine or cross-machine direction axis.

4. The embossed multi-ply tissue product of claim 1 wherein the second ply comprises a plurality of micro-embossments disposed thereon.

5. The embossed multi-ply tissue product of claim 4 wherein the plurality of micro-embossments have a density of at least about 50 embossments/cm² and cover at least about 6 percent of the second ply outer surface.

6. The embossed multi-ply tissue product of claim 1 wherein the embossing pattern disposed on the first ply comprises a plurality of substantially machine direction (MD) oriented line elements and plurality of substantially cross-machine direction (CD) oriented line elements.

7. The embossed multi-ply tissue product of claim 6 wherein the substantially MD oriented line elements are continuous and the substantially CD oriented line elements are discrete.

8. The embossed multi-ply tissue product of claim 7 wherein the substantially MD oriented continuous line elements consist of linear embossments and the substantially CD oriented discrete line elements consist of dot embossments.

9. The embossed multi-ply tissue product of claim 7 wherein the substantially MD and CD oriented line elements are curvilinear.

10. The embossed multi-ply tissue product of claim 1 wherein the first and second plies have a basis weight from about 14.0 to about 30.0 grams per square meter (gsm).

11. The embossed multi-ply tissue product of claim 1 having a sheet bulk from about 8.00 to about 12.00 cc/g, a basis weight from about 30.0 to about 60.0 gsm and a geometric mean tensile strength (GMT) from about 800 to about 1,700 g/3″.

12. A method of manufacturing a multi-ply, embossed, tissue product comprising the steps of:
a. providing an embossing unit comprising a first heatable embossing roll, a first counter roll and a marrying roll, wherein the first heatable embossing roll and first counter roll are arranged to form a first embossing nip therebetween and the first heatable embossing roll and marrying roll are arranged to form a second nip therebetween, the first embossing roll further comprises a plurality of male embossing elements arranged to form a first embossing pattern wherein at least a portion of the male embossing elements are linear elements oriented substantially in the machine direction or the cross-machine direction and have a sidewall angle from about 2 to about 5 degrees and a height less than about 1.00 mm;
b. conveying a first tissue ply into the first embossing nip to emboss the first tissue ply with the first embossing pattern;
c. conveying the first tissue ply into the second nip;
d. conveying a second tissue ply into the second nip; and
e. joining the first and second tissue plies together in the second nip to form a multi-ply tissue product;
wherein the first embossing pattern disposed on the first ply comprises a plurality of line elements substantially oriented in the machine or the cross-machine direction.

13. The method of claim 12 further comprising the steps of applying an adhesive to the surface of the first ply; and adhesively attaching the first and second plies.

14. The method of claim 12 further comprising the step of providing an adhesive supplying unit comprising an applicator roll for transferring an adhesive to the first ply or the second ply, and an engraved anilox for applying the adhesive to the applicator roll.

15. The method of claim 12 further comprising the step of providing a micro-embossing unit comprising a micro-embossing cylinder and a counter cylinder facing the micro-embossing cylinder to form a micro-embossing nip therebetween and conveying the first or second ply through the micro-embossing nip.

16. The method of claim 12 wherein the first heatable embossing roll is configured to be heated to a temperature ranging from 80 to 180° C.

17. The method of claim 12 further comprising the step of providing a wetting unit and wetting the first ply before it is received in the first embossing nip.

18. The method of claim 17 wherein the wetting step comprises the application of a of liquid in the range of 2 to 12 percent of the basis weight to the at least first ply.

19. The method of claim 12 wherein the first heatable embossing roll and first counter roll are mismatched.

20. The method of claim 19 wherein the first heatable embossing roll comprises a plurality of male elements having a first sidewall angle and the first counter roll comprises a plurality of female elements having a second sidewall angle, wherein the difference between the first and the second sidewall angles is at least about 3 degrees.
